(19) United States
(12) Patent Application Publication
(10) Pub. No.: US 2006/0216986 A1
(43) Pub. Date: Sep. 28, 2006

(54) Compact signal distribution device

(76) Inventor: Abbas Amiri-Hezaveh, Weston, MA (US)

Correspondence Address: EDWARD L. KELLEY;DBA INVENTION MANAGEMENT ASSOCIATES, 241 LEXINGTON STREET, BLDG. 15 UNIT 1A, WOBURN, MA, 01801, US

(21) Appl. No.: 11/090,490

(22) Filed: Mar. 25, 2005

(51) Int. Cl. H01R 13/60

(52) U.S. Cl. 439/535

(57) ABSTRACT

A signal distributing device (10) includes a signal receiving connector (16), such as a conventional two or three pronged male AC power plug, plugged into a signal source (12) such as a conventional female AC power wall outlet. The distribution device (10) delivers an AC power signal to a signal distribution hub (20) via a signal conveying element (18), such as a two or three stranded conducting wire. A signal distribution hub 20 includes an enclosure element that encloses a hollow volume and includes a central axis (60), a top wall (52), an opposed bottom wall (54), and at least three side walls (58), extending from the top wall (52) to the bottom wall (54). Each side wall includes at least one output interface connector (22) formed therein for interfacing with an external device. The distribution hub provides a compact power distributing device. In a preferred embodiment the distribution hub has eight sides with eight output connectors each facing radially outwardly from the central axis (60).

### BACKGROUND OR THE INVENTION

1. Field of the Invention

The invention provides an improved distribution hub for receiving a signal from a signal source and for conveying the signal to each of a plurality of external devices interfaced with the distribution hub. In particular, the signal distribution hub comprises a compact hub enclosure having a top wall, an opposing bottom wall and three or more side walls. The top, bottom and side walls are interconnected to enclose a hollow internal volume used to house signal conveying elements. Each side wall includes an output connector associated therewith and each output connector is configured to interface with an input connector from an external device and to deliver the signal to the external device.

2. Brief Description of the Prior Art

Signal distribution devices and especially electrical power signal distribution devices are widely used in commerce to receive an electrical power signal from a signal source and to deliver the electrical power signal to one or more external devices that require an electrical power signal to operate. In general, the electrical power signal distribution device provides a conductive path extending from an electrical power signal source, e.g. a conventional wall outlet, to each of a plurality electrical power signal using devices or external devices.

In a simple example, an electrical signal distribution device may comprise a conventional extension cord having an input connector attached at an input end, a conductive wire extending from the input end to an output end and a plurality of output connector elements conductively attached to the output end of the wire and housed within a distribution hub enclosure. In the extension cord example, the input connector plugs into a conventional AC power wall outlet and delivers AC power to each of the plurality of output connectors housed inside the distribution hub. One or more external devices interface with the output connectors to receive AC power therefrom.

Extension cords for indoor use in the home often provide a two pronged input connector interface for interfacing with a conventional AC power wall outlet. A first prong of the input connector is attached to a first end of a first conductive wire and a second prong of the input connector is attached to a first end of a second conductive wire. Each conductive wire terminates at its second end inside the distribution hub. The distribution hub houses one or more output connectors each configured to receive a two pronged input connector therein and each conductively connected to a corresponding one of the first and second wires. In the case of distributing an AC power signal, the signal includes a first channel attached to a positive terminal of an AC power source a second channel attached to a negative terminal of the AC power source. Accordingly, each external device attached to the distribution hub receives the same AC power signal received from the two pronged input connector plugged into the AC power wall outlet.

Other extension cords for outdoor use or for use with appliances may include a three pronged connector interface having the same two prongs and wires as described above but further including a third ground channel. In this case the input connector includes a third prong and a third conductive wire connects the input end to the distribution hub. Similarly, each output connector in the distribution hub includes an interface for a third prong.

Conventional extension cords may be used merely to provide access to AC power at a location remote from the AC wall outlet. In that case, the extension cord may be used to provide power to a single external device. Some conventional extension cords designed just for that purpose are configured with a single input connector and a single output connector and these may be used for large appliances that consume large amounts of AC power such as electric heaters, air conditioners, stove and or refrigerators. Other conventional extension cords are configured with a single input connector and a plurality of output connectors. Typical extension cords are configured with two three or four output connectors housed in a distribution hub enclosure.

Many extension cord distribution hub spatial configurations are known in the art. In particular, some compact designs are in use that provide from one to three output connectors. These are generally configured with a distribution hub comprising four mutually perpendicular side walls and two opposing end walls enclosing an internal volume and with output connectors associated with two opposing side walls. A popular configuration is manufactured by Coleman Cable under the TRINECTOR trade name. The TRINECTOR provides three output connectors housed inside its distribution hub. The distribution hub is bar shaped with four side walls and two opposed end walls with a conducting wire passing through one of the end walls. Two of the output connectors are associated with a first of the four side walls and a the third output connector is associated with a second of the four side walls, the second side wall being opposed to the first side wall such that input connectors are installed into the distribution hub through side walls that face in opposite directs, i.e. are 180 degrees apart.

More recently, power strips have been developed to deliver AC power to two or more external devices and particularly to deliver AC power to a related group of external devices such as a component system. Component systems may include multi-component audio, video, telephone, computer or other groupings of electronic devices that may be interconnected and grouped closely together during use such as on a desk or in a cabinet and that may be collectively used to perform a specific application. The power strip is basically configured like an extension cord except that the conductive wire length is usually shorter than the wire used in an extension cord and the power strip is usually configured with four or more output connectors housed in a distribution hub enclosure. In addition, power strips are usually configure with three-pronged connectors and with three separate conductors inside the wire element connected between the input connector and the hub. In addition, conventional power stripes may be equipped with an on off switch for selectively blocking AC power from reaching the output connectors. Conventional power strips may also be configured with a power surge protection device, such as a fuse or power dampening circuit, for preventing a power surge from reaching the output connectors.

A common configuration for a conventional power strip is a bar shaped hub enclosure with four mutually perpendicular and opposing side walls and two opposed end walls with each end wall being perpendicular with the four sides. Generally, the power strip has the wire entering the distribution hub through one of the end walls and includes all of its output connectors disposed on only one of the four side walls. This spatial layout necessitates a distribution hub with a longitudinal length that is directly proportional to the number of output connectors included in the hub and also proportional to the center to center spacing between output connector locations. One example of a power strip with a single row of output connectors disposed evenly spaced apart along one of its side walls is a power strip is manufactured by Tripp Lite, (see www.tripplite.com), as Part No. PS7224-20T, which includes 24 output connectors disposed along one side wall of a distribution hub having a bar configuration. In this example, the output connector locations have a uniform center to center spacing of 71 ml, (2.8 inch) and the overall longitudinal length of strip is 2.3 meters, (6 feet). In this example, each side wall has a uniform transverse width that is only marginally wider than the width of an output connector.

A second common configuration for a conventional power strip has four mutually perpendicular side walls and two opposed end walls with the wire entering the distribution hub through one of the end walls. In this case, all of its output connectors are disposed in two side by side rows on only one of the four side walls. Examples of a power strip with two side by side rows of output connectors disposed on one side of the output hub are manufactured by Fellowes Corp. as Part No. FEL99015, which include two side by side rows of output connectors with four output connectors in each row disposed on one side wall of a distribution hub having a bar configuration. As compared with single rows of output connector locations on a power strip this configuration provides the same number of output connector locations on a power strip with substantially one half of the longitudinal length.

Recently, more compact power distribution hub configurations have been made available commercially. In particular, a device known as the MIGHTY 8 SURGE PROTECTOR manufactured by Fellowes Corp. as Part No. FEL99090 has a distribution hub having opposing top and bottom walls and four side walls. In this case, the top wall includes three AC power output connectors disposed thereon and the opposing bottom wall includes two communication connector ports. The side walls of the MIGHTY 8 SURGE PROTECTOR are not all the same dimension and include one narrow side wall configured to receive a conductive wire therethrough and a second side wall is configured with three output connector ports formed therein. The remaining two side walls do not include output connectors associated with them. The MIGHTY 8 SURGE PROTECTOR provides a more compact distribution hub as compared to older power strips by providing output connectors on more than one wall. It also demonstrates that a distribution hub can be configured to distribute more than one signal type by providing AC power ports as well as communication ports on the same distribution hub. However, there is a need in the art for a signal distribution hub that is even more compact than conventional distribution hubs and that need is addressed by the present invention.

### BRIEF SUMMARY OF THE INVENTION

The present invention overcomes the problems cited in the prior by providing a signal distribution hub (20 and 100) that is configured with three or more side walls and preferably eight side walls with each side wall having at least on output interface connector (22) associated with it for distributing a signal to a plurality external devices (14).

In particular, a signal distributing device (10) connects to a signal source (12), receives a signal therefrom and delivers the signal into a distribution hub configured with at least three side walls (100) or e.g. configured with eight side walls (20). In general the distribution hub forms an enclosure that encloses a hollow volume therein. The enclosure has a central axis (60), and is formed by a top wall (52), an opposing bottom wall (54), and at least three side walls (58). Each side wall extends from the top wall (52) to the bottom wall (54) and is attached to each of the top and bottom walls. In addition, each side wall attaches to two other side walls along its length L. Accordingly, a normal axis of each side wall is substantially orthogonal to the central axis (60).

Each side wall is formed to provide access to the signal by providing access ports for interfacing with an interface connector (22) that is associated with the side wall. Each interface connector (22) receives the signal from the signal source (12) via signal conveying elements (68, 72, 76) disposed inside the enclosed volume. Since the signal may have multiple channels, a separate signal conveying element and a separate interface connector channel is provided for each signal channel. In addition, the signal may be an electrical signal that is conducted over conductive elements or the signal may be an optical signal such as a radiation beam that is conveyed through a fiber optic cable or the like. In addition, at least part of the signal path from the signal source (12) to the output interface connectors (22) may include a wireless transmission between a wireless signal transmitter and a wireless signal receiver.

The signal input interface connector (16) interfaces with the signal source (12) and delivers the signal to the signal conveying elements (68, 72, 76) inside the hub enclosure. The input interface connector (16) may be incorporated in the distribution hub or may comprise a separate connector element connected to the distribution hub by a cable (18).

### BRIEF DESCRIPTION OF THE DRAWINGS

The features of the present invention will best be understood from a detailed description of the invention and a preferred embodiment thereof selected for the purposes of illustration and shown in the accompanying drawings in which:

FIG. 1 illustrates a schematic diagram of a signal source and a signal distribution device according to the present invention delivering the signal to a plurality of external devices.

FIG. 2 illustrates a preferred signal distribution hub according to the present invention and shown in exploded view.

FIG. 3 illustrates an assembled signal distribution hub according to the present invention with its top wall removed.

FIG. 4 illustrates an example of a three sided signal distribution hub according to the present invention and shown in isometric view.

### DETAILED DESCRIPTION OF THE INVENTION

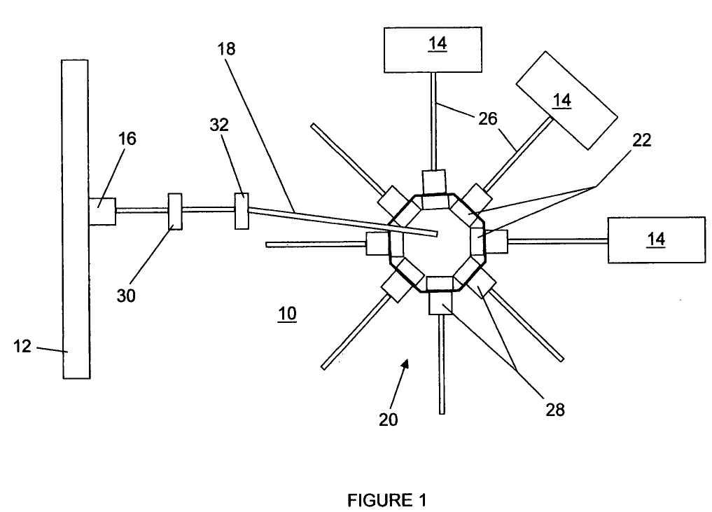

FIG. 1 depicts a schematic view showing various elements of a signal distribution system. In particular, a signal distribution device 10, according to the present invention, receives a signal from a signal source 12 and delivers the signal to one or more external devices 14. The signal may comprise an analog electrical power signal, such as may be delivered from conventional wall outlet delivering AC or DC power, or the signal may comprise any analog electrical signal, such as, but not limited to, an audio, video, telephone or other communication signal or combination thereof. Alternately, the signal may comprise a digitalized electrical signal such a digital data communications signal. In other applications, the signal may comprise an optical data signal such as a modulated radiation beam. In addition, the signal may include a plurality of parts with each part being delivered on a different signal channel. For example, a power signal may have a positive part delivered by a positive power source terminal over a first channel of the distribution device 10 and a negative part delivered by a negative power source terminal over a second channel of the distribution device 10 and a third channel of the distribution device 10 may provide a conductive path to ground. In other examples, the signal may comprise dozens of signal elements each delivered over a different channel. In the case of an optical signal, the signal many included hundreds of channels propagating through a single fiber optic element. Accordingly the distribution device 10 may be configured to receive a signal having a plurality of component parts to and to deliver each component part of the signal to each of the external device attached to the distribution hub 20. Moreover, the signal may be generated locally, e.g. when the signal generator 12 includes a signal generating element, or the signal may be delivered to the signal generator 12 from a remote location via a conductor, wireless transmitter or fiber optic element. Accordingly, the signal source 12 may comprise an active signal generator or a signal delivery device such as a circuit or network output terminal or node. In any event, a signal is delivered from the signal generator 12 to an interface element 16.

According to the present invention, the signal distribution device 10 comprises an input interface connector 16 configured to receive the signal from the signal source 12. The input interface connector 16 may comprise an electrical connector, a fiber optic coupler or a wireless signal receiver for receiving a wireless signal from a signal transmitter. Generally, the input interface connector 16 is configured with a separate pin, prong or other interface element for each channel of the distribution device 10. In one embodiment, the input interface element 16 is attached to an input end of a cable 18 and an output end of the cable 18 terminates inside a signal distribution hub, generally referenced by numeral 20. The signal distribution hub 20 includes a plurality of output interface connectors 22 housed therein and configured to interface with a signal receiving elements 28. The signal receiving element 28 are usually of the same type and configuration as the input interface connector 16. Additional elements housed within the distribution hub 20, detailed below, are configured to receive the input signal from the signal source 12 and deliver it to each of the output interface connectors 22. In general, the entire input signal is delivered to each of the output connectors 22.

The distribution hub 20 may be used to interface with a plurality output device 14 for delivering the entire input signal to each of the plurality of output devices 14. Each output device 14 includes a cable 26 having an input connector 28 attached to its input end. In most configurations, the input connector 28 is of the same type and configuration as the interface connector 16. Each external device 14 may interface with the output hub 20 by interfacing its input connector 28 with one of the plurality of output interface connectors 22 to receive the input signal therefrom. In other embodiments, the input connectors 28 and the output interface connector 22 may be of a different type and configuration from the interface connector 16. In a further variation, the external device 14 may include an input connected 28 formed directly therein and may connect with an output connector 22 without the cable 26.

The signal distribution device 10 may also include a switch 30 installed between the signal source 12 and the output interface connectors 22 for selectively blocking the input signal from reaching the output connectors 22. In addition, the distribution device 10 may also include a signal processing device 32 for processing the signal received from the signal source 12 to thereby deliver a processed signal to each output connector 22. Signal processing may include, but is not limited to a power surge protector, for limiting the power of the signal transmitted to the output devices 24, a power or frequency transformer, for changing the voltage and or modulation frequency of the signal, an amplifier for increasing the amplitude of the signal and any other electrical and or optical signal processing device as may be required by the application. Also, while the switch 30 and the signal processor 32 are shown associated with the cable 18, either or both of these elements may be housed inside the output hub 20 or inside the interface connector 16.

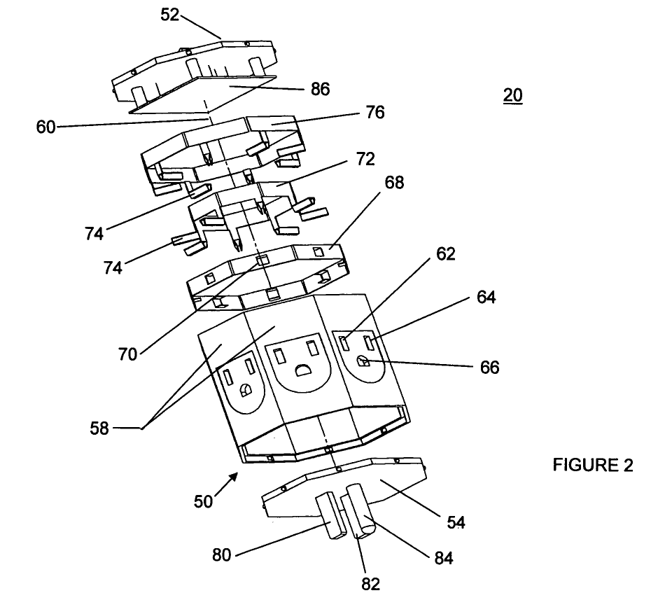

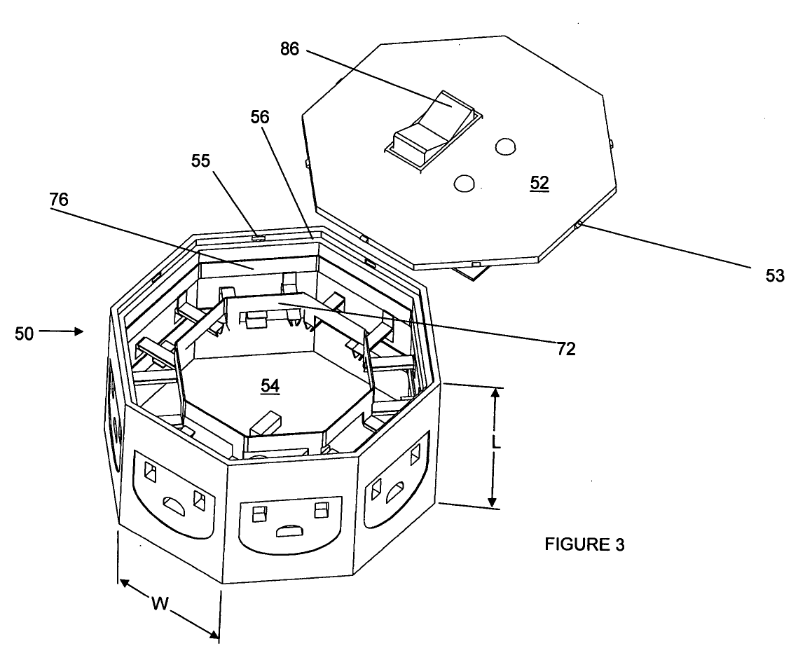

Referring now to FIGS. 2 and 3, a preferred embodiment of a distribution hub 20 is shown in exploded and partially disassembled views. As shown therein, the distribution hub 20 comprises an enclosure element 50 formed by eight side walls 58. The enclosure element 50 may be molded as a unitary element or formed from component elements. A top wall 52 and a bottom wall 54 interconnect with the enclosure element 50 to enclose a hollow volume. The enclosure element 50 is formed with a shoulder 56 at its top end for receiving an outer perimeter of the top wall 52 thereon. The top wall 52 and enclosure 50 are attached together by a plurality of detent elements 53 located on the top wall 52 and a plurality of corresponding cavities 55 formed in the enclosure 50. The detents 53 interlock with the cavities 55 when the top wall 54 is snapped into engagement with the enclosure element 50. The bottom wall 54 is similarly attached to the enclosure 50. However, any appropriate attaching means may be used to attach the top and bottom walls to the enclosure 50. Preferably, the fit between the enclosure element 50 and the top and bottom walls (52, 54) is tight enough to block contaminants from entering the hollow volume and to provide a safety cover in accordance with well known electrical and optical signal transmission safety standards. In addition, some applications may require that the hollow cavity be sealed with a gas, liquid or light tight seal.

The enclosure element 50 comprises a plurality of side walls 58, which in the preferred embodiment shown in FIGS. 2 and 3 is eight side walls 58. A central axis 60 extends longitudinally through the hollow volume enclosed by the distribution hub 20. Each side wall 58 has a length L that is substantially parallel with the central axis 60 and the length L substantially extends from the top wall 52 to the bottom wall 54. Each side wall 58 has a width W that is transverse to the length L and to the central axis 60. In addition, each side wall 58 is in mating contact with at least two other side walls along its length L. In the preferred embodiment, the enclosure 50 is formed with each of the eight side walls having a substantially equal width W.

A plurality of signal conveying elements are disposed inside the hollow volume and configured to receive a signal from the signal source 12 and deliver the signal to each of external device input connectors 28 that are connected to the distribution hub 20. According to a preferred embodiment of the invention, each side wall 58 is configured to interface with one external device input connector 28. In the example shown in FIGS. 2 and 3, each side wall 58 is configured to receive three prongs of a conventional three pronged male AC power connector. Two bar shaped prongs pass through the two slotted apertures 62, 64, and a third round prong passes through a rounded aperture 66 each passing through the side wall 58. The apertures (62, 64 and 66) are sized, shaped and spatially oriented in accordance with conventional three pronged AC connector standards.

Inside the hollow volume, a plurality of signal conveying elements interface with the two slotted apertures 62, 64, and the rounded aperture 66 formed in each side wall 58 to form an output interface connectors 22 associated with each side wall 58. The signal conveying elements are formed to provide eight output interface connectors 22 each configured to receive a conventional three pronged AC power connector 28 therein and to deliver an AC power signal to one external device 14. In the example embodiment shown in FIGS. 2 and 3, the eight output interface connectors 22 are jointly formed by three conductive elements.

A first conductive element 68 is an octagonal shaped sheet metal band having eight apertures 70 passing therethrough. The band is fixedly supported inside the hollow volume and positioned to align each of the eight apertures 70 with each of the eight rounded apertures 66 that pass through the side walls 58. The first conductive element 68 is connected via a continuous conductive path extending out of the distribution hub 20 to the signal source 12 by a conductive wire inside the cable 18 and by an associated rounded prong on the input interface connector 16 to the signal source 12. In the case of an AC power signal, the first conductive element 68 is connected to ground through the signal source 12.

A second conductive element 72 is an octagonal shaped sheet metal band having eight conductive receiving elements 74 extending therefrom. The second conductive element 72 is fixedly supported inside the hollow volume and positioned to align each of the eight receiving elements 74 with the first slot shaped aperture 64 that passes through each side walls 58. The second conductive element 72 is connected via a continuous conductive path extending out of the distribution hub 20 to the signal source 12 by a conductive wire inside the cable 18 and by an associated prong on interface connector 16. In the case of an AC power signal, the second conductive element 72 may connected to a positive terminal of a power source delivering AC power to the signal source 12.

A third conductive element 76 is an octagonal shaped sheet metal band having eight conductive receiving elements 78 extending therefrom. The third conductive element 76 is fixedly supported inside the hollow volume and positioned to align each of the eight receiving elements 78 with the second slot shaped aperture 62 that passes through each side walls 58. The third conductive element 76 is connected via a continuous conductive path extending out of the distribution hub 20 to the signal source 12 by a conductive wire inside the cable 18 and by an associated prong on interface connector 16. In the case of an AC power signal, the third conductive element 76 is connected to a negative terminal of a power source delivering AC power to the signal source 12.

In an alternate embodiment of the distribution device 10, according to the present invention, the cable 18 may be eliminated by forming the interface connector 16 on one of the distribution hub enclosure walls, such as the bottom wall 54. This configuration is shown in FIG. 2 by way of example. As shown, three male connector prongs 80, 82 and 84 extend through the bottom wall 54 and may be interfaced directly with the signal source 12. In this case, the rounded prong 84 is conductively connected with the first conductive element 68, e.g. by a wire or by an intermediate conductive element, not shown. The wire or conductive element extends between the first conductive element 68 and the rounded prong 80. Similarly, each of the rectangular prongs 80 and 82 are conductively connected with a corresponding one of the second conductive element 72 and the third conductive element 76.

In a further aspect of the present invention, each of the octagonal shaped sheet metal band 68 and 76 are sized to fit snuggly against the inside surfaces of the side walls 58 as shown in FIG. 3. In the case of the octagonal shaped sheet metal band 76 each of the conductive elements 78 extend radially inwardly toward the central axis 60 to receive prongs inserted through the slotted apertures 62. With each of the octagonal shaped sheet metal bands 68 and 76 that are snugly fit against the inside of the side walls, connective elements that connect the sheet metal bands 68 and 76 to the corresponding signal channel may be incorporated within or attached to the side walls 58.

The third octagonal shaped sheet metal band 72 is sized with smaller octagonal side dimensions and is supported separately from the side walls 58. The metal band 72 is formed with each of its eight conductive elements 74 extending radially outwardly from the central axis 60 to receive prongs inserted through the slotted apertures 64. This configuration keeps the sheet metal band 72 electrically isolated from the sheet metal bands 68 and 76 while placing its conductive elements in position to receive prongs from an input connector 28. The third sheet metal band 72 may be supported by posts, not shown, that extend upward from the bottom wall 54 and include the conductive elements formed therein to connect the metal band 72 to the appropriate channel of the input signal.

In another example embodiment, a switch actuator 86 is supported in the distribution hub top wall 52 to provide user access thereto. The actuator 86 actuates a switch, not shown, to open or close a signal pathway between the signal source 12 and the output connectors 22. In the case of the three pronged AC power signal, the switch need only open or close the conductive pathway between one of the positive or negative terminals of a power source and its corresponding conductive element 72 or 76.

In a further embodiment, a signal processing element 32 comprises a PC board 86 configured with a signal processing circuit attached thereto and interconnected within the signal path for processing the signal.

Thus in accordance with the present invention, a signal distribution device 10 comprises input means for receiving a signal from the signal source 12 and output means for distribution the signal to one or more external devices 14. The input means may comprise only the input connector 16 configured to receive the signal from the signal source 12. Alternately, the input means may further include a signal carrying cable 18 connected between the input connector 16 and the distribution hub. The distribution hub 20 includes a surrounding enclosure 50 that includes at least three side walls 58 for surrounding a hollow volume. Each side wall 58 is in contact with two other side walls along its length in order to enclose the hollow volume. In addition, the distribution hub includes at least one output connector 22 associated with each of the at least three side walls 58 for interfacing with an input connector 28. In addition, the hollow volume is further bounded by a top wall 52 and a bottom wall 54. The distribution hub 20 is also configured with signal carrying elements, (68, 72 and 76) each configured to receive a separate channel of the signal from the input means and deliver the entire signal to each of the output connectors 22.

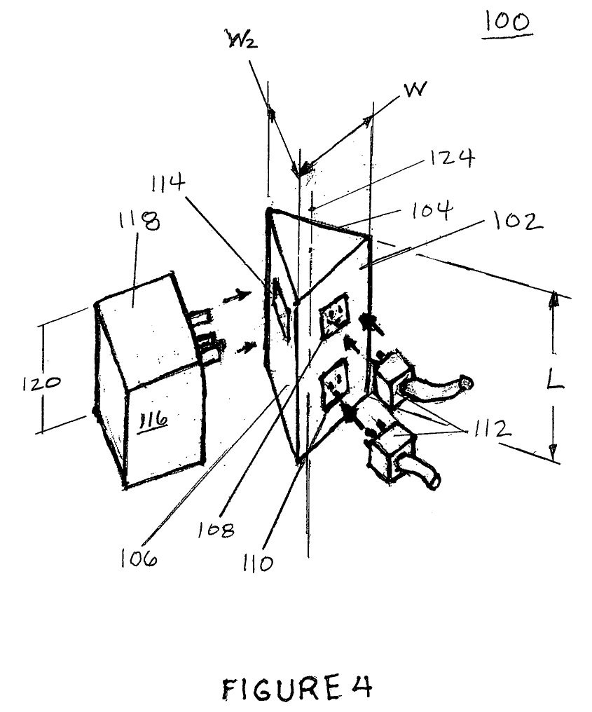

Turning now to FIG. 4 another example of a distribution hub 100 according to the present invention is shown in isometric view. The distribution hub embodiment 100 is configured with three side walls 102, 104 and 106. The side walls 102 and 104 are substantially equal in width, W, and the side wall 106 has a wider width W₂. In the example, each of the side walls 102 and 104 is configured with two output connector interfaces 108 and 110 for receiving two external device input connectors 112. In this case, each of the connectors 112 is a conventional AC power connector with approximate cube dimensions of approximately 2.3-3.0 cm on a side, (1.0-1.2 inch). To accommodate the standard sized input connectors 112, the side wall width W may range from about 2.5-6.0 cm, (0.98-2.4 inches), however, wider widths can be used. In the length axis, the approximate minimal center to center spacing between the connector interfaces 108 and 110 is 2.5 cm, (0.98 inches) and the length L may be as short as about 5.0 cm (1.97 inches).

The side wall 106 is configured with only one connector interface 114 and it is offset along the length L to be positioned proximate to an enclosure top wall 122. In this case, the side wall 106 is configured to receive a larger volume non-standard external device input connector 116. An example of larger volume non-standard input connectors may include an input connector that includes a power transformer incorporated therein such as is commonly used in various component systems. In this case, the input connector 116 may have a square cross-section 118 with side dimensions of approximately 5.0 cm per side, (1.9 inches) and a length 120 of approximately 5.0-10.0 cm, (1.9-3.9 inches). Accordingly, the width W₂ may be in the range of about 5.0-14.0 cm, (2.0-5.5 inches) and the hub length L may range from about 5.0-11.0 cm (1.9-4.3 inches). Accordingly, the distribution hub 100 is configured with connector interfaces for interfacing with four external devices that utilize standard sized power connectors and these four external devices may be plugged into the two output connector interfaces 108 and 110 provided on each of the side walls 102 and 104. The distribution hub 100 is also configured to interface with one larger non-standard sized power connector 116 plugged into the output connector interface 114. The advantage of the spatial configuration of the distribution hub 100 over the spatial configurations of conventional power distribution hubs is that the distribution hub 100 is very compact. In particular, the distribution hub 100 may interface with five external devices, including one larger non-standard input connector 118 with a distribution hub length L of approximately 5.0 cm, (1.9 inches).

In addition, using the three-sided embodiment of the distribution hub 100, and increasing the length L to approximately 10.0 cm, (3.9 inches), 5 additional output interface locations can be added along the length axis without increasing the widths W and or W₂. In particular, by doubling the length of the distribution hub 100 and providing the same output connector arrangement in mirror image, the resulting distribution hub may interface with ten external devices, including two larger non-standard input connectors 118.

Similarly, an increase in any one of the widths W and W₂ can be used to add output interface locations spaced aside by side along the width axis without increasing the length L. Moreover, as is shown in the description of the preferred embodiment above, an increase in the number of side walls to eight or more side walls even further increases the number of external devices that can be interfaced with the distribution hub and the hub spatial volume footprint is considerably smaller than convention distribution hubs that can interface with eight external devices.

As shown in FIG. 4, the distribution hub 100 has a central axis 124 and each of the side walls 102, 104 and 106 have a normal axis, not shown, that is substantially perpendicular to the central axis 124. As will be recognized by those skilled in the art, distribution hubs like the hub 100 shown in FIG. 4 can be configured with four, five, six, seven, eight or more side walls each having one or more output connector interface locations facing away from the central axis. In addition, an increase in the length of a distribution hub by a factor of two can be used to easily double the number of output connector ports from one per side wall to two per side wall. In this case, output port locations are spaced apart along the length dimension while keeping the width dimension fixed.

In one particularly preferred configuration, the distribution hub 20 shown in FIGS. 2 and 3 has eight side walls 58 with each side wall configured with one connector interface location for interfacing with a standard sized AC power connector. In this case, the width W each side wall 58 is approximately 2.5-4.0 cm, (0.98-1.6 inches) and the length L may range from approximately 2.5-6.0 cm, (0.98-2.4 inches). In this configuration, the distribution hub 20 may interface with eight external devices and is considerably more compact than conventional distribution hubs having the same number of output interface connectors. In addition, the configuration of the distribution hub 20 can be readily adapted to interface with 16 external device by doubling the length L and installing a second set of conducting elements 68, 72 and 76 inside the enclosure above or below the first set of conducting elements for forming a second set of eight output connectors 22 positioned opposed to the first set of eight output connectors 22 along the central axis 60. In this case a distribution hub having eight sides may provide 16 output interface connectors in a very compact enclosure. In particular, such an enclosure has eight side walls 58 each side wall having a width W of approximately 2.5-4.0 cm, (0.98-1.6 inches) and a length L of approximately 5.0-12.0 cm, (1.9-4.8 inches).

It will also be recognized by those skilled in the art that, while the invention has been described above in terms of preferred embodiments, it is not limited thereto. Various features and aspects of the above described invention may be used individually or jointly. Further, although the invention has been described in the context of its implementation in a particular environment, and for particular applications, e.g. for distribution of AC power signals, those skilled in the art will recognize that its usefulness is not limited thereto and that the present invention can be beneficially utilized in any number of environments and implementations including but not limited to any signal distribution hub. Accordingly, the claims set forth below should be construed in view of the full breadth and spirit of the invention as disclosed herein.

1. A signal distributing device (10) for connecting to a signal source (12) for receiving a signal therefrom and for distributing the signal to each of a plurality of external devices interfaced therewith comprising:
a signal distribution hub enclosure for enclosing a hollow volume therein, the enclosure having a central axis (60), a top wall (52), an opposed bottom wall (54), and at least three side walls (58), extending from the top wall (52) to the bottom wall (54) and attaching to each of the top wall and the bottom wall, and wherein each side wall has a normal axis that is substantially orthogonal to the central axis (60), and further wherein each of the at least three side walls extends between and attaches to two other of the at least three side walls to thereby enclose the hollow internal volume within the hub enclosure;
signal receiving means (16) interfaced with the signal source (12) for receiving the signal therefrom and delivering the signal into the hollow volume; and,
at least one output interface connector means (22) disposed on each of said at least three side walls (58) for receiving the signal from the signal receiving means (16) and delivering the signal to an external device (14).

2. The electrical signal distributing device according to claim 1 wherein each of the at least three side walls has a substantially equal transverse width W.

3. The electrical signal distributing device according to claim 2 wherein the transverse width W minimally exceeds the transverse width of the output interface connector means (22).

4. The electrical signal distributing device according to claim 3 wherein the at least three side walls comprises one of; four side walls, five side walls, six side walls, seven side walls, eight side walls, nine side walls and ten side walls.

5. The electrical signal distributing device according to claim 1 wherein the signal receiving means (16) comprises male connector elements (80, 82, 84) extending through and protruding from one of the bottom wall (54) and the top wall (52).

6. The electrical signal distributing device according to claim 1 wherein the signal receiving means (16) comprises:
an interface connector (16) attached to the signal source (12); and,
a signal conveying cable (18) extending from the interface connector (16) and through one of the top, bottom and side walls of the distribution hub enclosure for delivering the signal to each of the output interface connectors means (22).

7. The electrical signal distributing device according to claim 6 further comprising signal conveying elements (68, 72 and 76) housed inside the distribution hub enclosure for forming the at least one output interface connector means (22) disposed on each of the at least three side walls and wherein each of the signal conveying elements (68, 72 and 76) is attached to the signal conveying cable (18).

8. The electrical signal distributing device according to claim 5 wherein the male connector elements (80, 82, 84) convey the signal to signal conveying elements (68, 72 and 76) housed inside the distribution hub enclosure for forming the at least one output interface connector means (22) disposed on each of the at least three side walls.

9. The electrical signal distributing device according to claim 1 further comprising a switching element installed between the signal receiving means and the at least one interface connector means (22) disposed on each of said at least three side walls (58) and configured to selectively prevent the signal from reaching the at least one interface connector means (22) disposed on each of said at least three side walls (58).

10. The electrical signal distributing device according to claim 1 further comprising a signal processing element installed between the signal source (12) and the at least one interface connector means (22) disposed on each of said at least three side walls (58) for processing the signal in accordance with signal processing criteria.

11. The signal distributing device according to claim 1 wherein the signal comprises a power signal and wherein the signal source 12 comprises a conventional wall outlet for dispensing one of an AC and a DC power signal.

12. The signal distributing device according to claim 1 wherein the signal comprises more than one signal channel and wherein the distribution device (10) is configured with a separate conveying path for each of the more than one signal channels.

13. The signal distributing device according to claim 1 wherein the at least three side walls comprises eight side walls (58) with each side wall (58) having a substantially equal transverse width W of less than 6.0 cm.

14. The signal distributing device according to claim 13 wherein the distribution hub has a length L that is less than 6.0 cm.

15. The signal distributing device according to claim 1 wherein the at least three side walls comprises eight side walls (58) with each side wall (58) having a substantially equal transverse width W in the range of 2.5 to 4.0 cm.

16. The signal distributing device according to claim 15 wherein the distribution hub has a length L that is in the range of 2.5 to 6.0 cm.

17. The signal distributing device according to claim 1 wherein each of the at least three side walls (58) has a substantially equal transverse width W of less than 6.0 cm.

18. The signal distributing device according to claim 1 wherein a first portion of the at least three side walls (58) each have a substantially equal transverse width W in the range of 2.5 to 4.0 cm for interfacing with a first type of input connector 28 and wherein at least one of the at least three side walls (58) has a transverse width W₂ in the range of 5.0-14.0 cm for interfacing with a second type of input connector 28.

19. The signal distribution device according to claim 1 wherein the at least one output interface connector means 22 disposed on each of the at least three side walls (58) comprises at least two output connector interface means (22) disposed on each of the at least three side walls (58) and wherein the at least two output connector interface means (22) are spaced apart one above another along a length (L).

20. The signal distribution device according to claim 1 wherein the at least one output interface connector means 22 disposed on each of the at least three side walls (58) comprises at least two output connector interface means (22) disposed on one or more of the at least three side walls (58) and wherein the at least two output connector interface means (22) are spaced apart one above another along a length (L).

21. The signal distribution device according to claim 1 wherein the at least one output interface connector means 22 disposed on each of the at least three side walls (58) comprises at least two output connector interface means (22) disposed on one or more of the at least three side walls (58) and wherein the at least two output connector interface means (22) are disposed one beside the other along a width (W).
